(19) United States
(12) Patent Application Publication
(10) Pub. No.: US 2004/0230580 A1
(43) Pub. Date: Nov. 18, 2004

(54) Method and apparatus for performing batch updates to records over a network

(76) Inventors: Nai-Chun Li, Hsinchu (TW); Kuen-Pei Li, Hsinchu (TW); Si-Shun Yeh, Hsinchu (TW); Kung-Cheng Tu, Hsinchu (TW); Chao-Wen Hsiao, Hsinchu (TW)

Correspondence Address: Kenton R. Mullins, Stout, Uxa, Buyan & Mullins, LLP, Suite 300, 4 Venture, Irvine, CA, 92618, US

(21) Appl. No.: 10/437,783

(22) Filed: May 14, 2003

(51) Int. Cl. G06F 7/00

(52) U.S. Cl. 707/10

(57) ABSTRACT

A method is disclosed for batch updating records in a computer system that includes a server module, a database coupled to the server module, and a client module coupled to the server module. The method includes the steps of receiving a user identification code and a password code at the server module for verifying the identity of a user of the client module, opening an import file at the client module, and determining whether the information of the import file satisfies certain criteria. The method further includes the steps of downloading a server work file from the server module to the client module, updating the server work file using the import file, and uploading the server work file from the client module to the server module.

### BACKGROUND OF THE INVENTION

1. Field of the Invention

The present invention relates generally to the field of updating information in a client-server system, and more particularly to a method and apparatus for performing batch updates to records over a network.

2. Description of the Related Art

With reference to FIG. 1, a computer system 100 typically includes a main computer (“server”) 102 in which one or more databases 104 are located, one or more remote computers (“clients”) 106, and a network 108, which provides the communication means between the clients 106 and the server 102. Information, e.g. data, is typically maintained in the databases 104 or storage devices such as random-access memory, hard drives, tape drives, and the like, and is managed by database management software. The information can be stored as a data record in a database table. The server 102 typically includes the database management software, which controls access to and modification of the information under its control. The server 102 can be a personal computer or a mainframe computer with a processing unit 109 having commercially available or specifically designed database management software. Examples of commercially available database management software include DB2 from IBM Corporation and Oracle7 from Oracle Corporation.

The clients 106 are typically hand-held devices, personal computers, workstations, or other kinds of computer monitors or terminals. Preferably, the clients 106 are IBM compatible computers. Each of the clients 106 can include a processing unit 110 having a CD-ROM drive 112 for loading CD-ROM disks 114, a monitor 116, a keyboard 118, and a mouse 120. Also, the clients 106 can each have separate storage devices 122, which are usually smaller than the server's storage device 104. The clients' storage devices 122 are generally made up of a combination of a random-access memory and a hard drive. The clients 106 can be either remote from the server 102 or collocated with the server 102.

The clients 106 typically include applications such as word processors, spreadsheets, electronic mail, and database interface software that communicate with the server 102 to access information in the database 104, to update information in the database 104, and to add new information to the database 104. Quite often, when a user of the application needs information, the application contacts or queries the database 104 to find and retrieve the desired information for use in the application.

One common usage of the network 108 is to carry or transmit the information. The network 108 typically includes commercial telephone lines, dedicated communication lines, and/or cable lines to carry the information between the server 102 and the clients 106. Continuously sending information over the network 108 is costly, not only in terms of operating the network 108, but also in terms of time and computer resources. Therefore, it is desirable to minimize the number of times the information passes over the network 108.

One way to reduce network traffic and demand of the server 102 is to copy a portion of the data record stored in the server 102 into the client's storage device 122. Therefore, the data record can be accessed by the client applications without having to send commands or information to the server 102 each time the data record is needed. A protocol between the clients 106 and the server 102 can ensure that the data record in the client's storage device 122 is current with the corresponding data record in the database 104. Thus, the client's storage device 122 is periodically updated to ensure that the information stored in the client's storage device 122 accurately reflects the information stored in the server's storage device 104. However, prior approaches to performing database updates over the network 108 can be slow and limited as a result of, for example, the server 102 only allowing the clients 106 to update one record at a time.

### SUMMARY OF THE INVENTION

One embodiment of the present invention is a method for batch updating records in a Poseidon system that includes a server module, a database, and a client module. The method includes the steps of downloading a server work file having a plurality of records from the server module to the client module, verifying the accuracy of the server work file, and updating the plurality of records of the server work file. The method further includes the steps of uploading the server work file from the client module to the server module, verifying the format of the server work file, and sending the server work file to the database.

Another embodiment of the present invention is a method for batch updating records in a computer system that includes a server module, a database coupled to the server module, and a client module coupled to the server module. The method includes the steps of receiving a user identification code and a password code at the server module for verifying the identity of a user of the client module, opening an import file at the client module, and inputting updated records information into the import file. The method further includes the steps of downloading a server work file from the server module to the client module, saving the import file to the server work file, and uploading the server work file from the client module to the server module.

Another embodiment of the present invention is a method for batch updating records in a computer system that includes a server module, a database coupled to the server module, and a client module coupled to the server module. The method includes the steps of receiving a user identification code and a password code at the server module for verifying the identity of a user of the client module, opening an import file at the client module, and determining whether the information of the import file satisfies certain criteria. The method further includes the steps of downloading a server work file from the server module to the client module, updating the server work file using the import file, and uploading the server work file from the client module to the server module.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is a simplified block diagram of a prior art client-server computer system having a server and multiple clients;

FIG. 2 is a simplified block diagram of a Poseidon system in accordance with the present invention;

FIG. 3 is a simplified flow chart illustrating a method for batch updating records in the Poseidon system of FIG. 2;

FIG. 4 is a login graphical user interface in accordance with the present invention;

FIG. 5 is a simplified flow chart illustrating a method for batch updating records in the Poseidon system of FIG. 2; and

FIG. 6 is a batch update graphical user interface in accordance with the present invention.

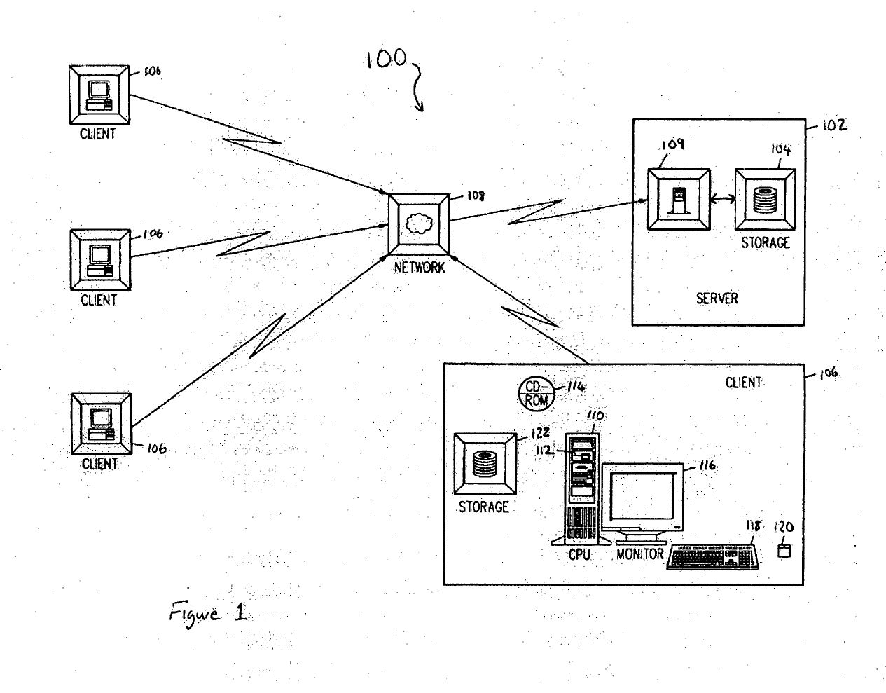

### DETAILED DESCRIPTION OF THE PRESENTLY PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale.

In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims.

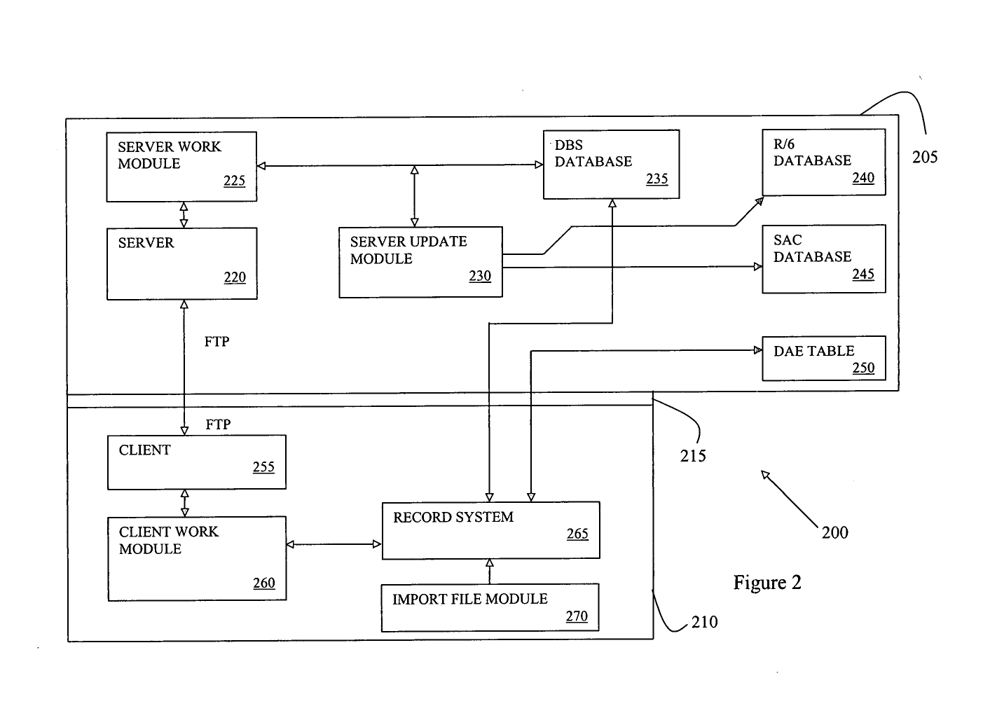

FIG. 2 is a simplified block diagram of a computer system 200, which in the illustrated embodiment is a Poseidon system. As used herein, the term Poseidon refers to an IBM Computer Integration Manufacture (CIM) System Solution Name. The Poseidon system 200 includes a server module 205 and a client module 210. The server module 205 communicates with the client module 210 via a network 215, e.g., the Internet, that is configured to use the transmission control protocol/Internet protocol (TCP/IP). TCP/IP allows the client module 210 to request and receive information, such as a Web page, from the server module 205. The client module 210 can also transmit information to the server module 205.

File transfer protocol (FTP), a standard Internet protocol, is one way to exchange information, e.g., files, between the server module 205 and the client module 210 over the network 215. FTP is commonly used to download programs and files from the server module 205 to the client module 210. For example, the Web browser on the client module 210 can make FTP requests to download programs and files from the server module 205 that are selected by the user from a Web page. The client module 210 can also use FTP to access and update files that are received from and located at the server module 205.

The server module 205 includes a server 220, a server work module 225, a server update module 230, a DBS database 235 (wherein DBS is a MES database name, and DBS source is made from Basic Record System and to collect a portion of FAB on-line data), a R/6 database 240 (wherein R6 is an IBM Server Machine name, and R/6 database denotes all system R6 Server machine databases), a SAC database 245 (wherein each SAC, or Sub Area Control, server can control different area of CIM System in FAB, so the SAC database source is to collect FAB on-line data), and a DAE table module 250 (wherein DAE is an IBM communication protocol, a DAE table is established on each SAC server, and DAE table data is also from FAB on-line data). The server 220 includes a network interface (not shown), which is used to connect the server module 205 to the network 215. The server 220 includes software routines that perform various operations such as connecting to the client 255 and the databases and providing read/write access to the client 255 and the databases. The server 220 may invoke the software routines to access and update the databases and to retrieve data objects from the databases for processing by the server module 205. Preferably, the server 220 is a R6 computer server with an AIX operating system.

The server work module 225 is coupled to the server 220 and the DBS database 235. The server work module 225 is used to access, create, store and update server work files. The server work files can include information in the form of a number of tables, which include a number of identifiers and records. The server update module 230 is coupled to the server work module 225, the DBS database 235, the R/6 database 240, and the SAC database 245. The server update module 230 is used to access, create, store and update server update files. The server update files include information in the form of a number of tables, which include a number of identifiers and records.

The databases 235, 240 and 245 may be relational databases where data is organized into tables where the columns represent the fields and the rows or records represent data objects. Each record might have an identifier, which uniquely identifies the record. The user of the relational database may not need to know how the databases are physically constructed to access and update the data in the databases. In one embodiment, the data is accessed and updated using a query-language such as a standard query language (SQL), which is used to create queries to the databases. For example, Microsoft SQL is commercially available relational database software that allows the user to create queries to the databases.

The DAE table module 250 is used for batch record security control. During each data transfer between the server module 205 and the client module 210, the DAE table module 250 monitors the network 215 and the record system 265 to ensure that the data and file transfers are proper.

The client module 210 includes a client 255, a client work module 260, and a record system 265. The client 255 includes a network interface (not shown), which is used to connect the client module 210 to the network 215. In one embodiment, an open database connect (ODBC) network interface can be used by the client module 210 to access and update the databases 235, 240 and 245 over the network 215. For example, Microsoft ODBC is a commercially available network interface that allows the user of the client module 210 to access and update the databases 235, 240 and 245 over the network 215. The client 255 includes software routines that perform various operations such as connecting to the server 220 and the databases and providing read/write access to the server 220 and the databases. The client 255 may invoke the software routines to access and update the databases and to retrieve data objects from the databases for processing by the client module 210. Preferably, the client 255 is a computer system with an OS2 or NT operating system.

The record system 265 is a storage device where data is organized and stored as tables where the columns represent the fields and the rows or records represent data objects. Each record might have an identifier, which uniquely identifies the record. The record system 265 is coupled to the client work module 260, the DBS database 235, and the DAE table module 250. When the client 255 is a computer system with an NT operating system, the record system 265 can be replaced with a B/R batch update system 265. The B/R batch update system 265 is a system that can batch update B/R system data with import file. In addition, an import file module 270 can be coupled to the record system 265 for creating, generating, opening and storing import files.

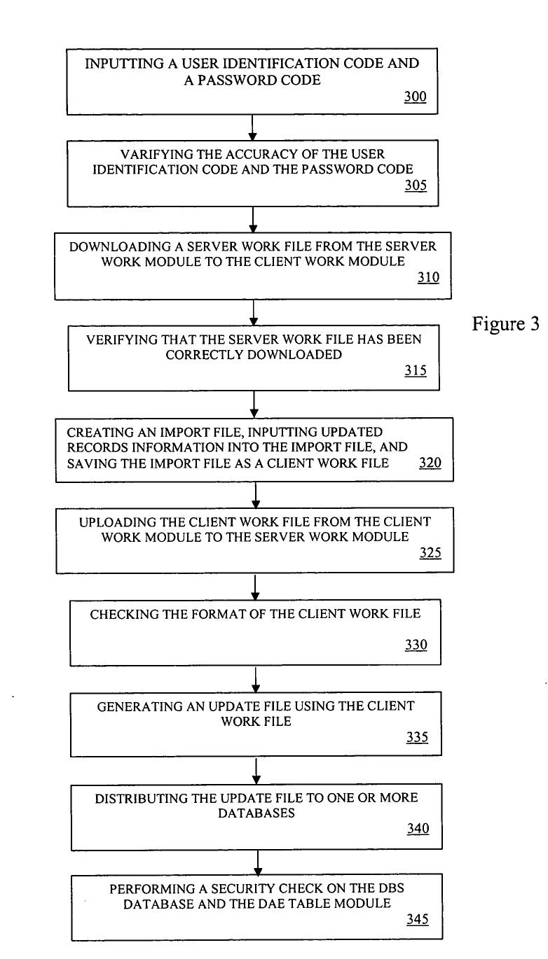

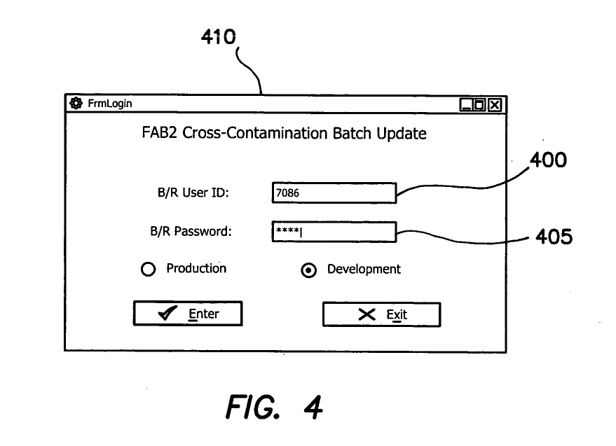

FIG. 3 is a simplified flow chart illustrating a method for batch updating records in the Poseidon system of FIG. 2. At step 300, a user of the client module 210 inputs a user identification code 400 and a password code 405 into a login graphical user interface 410 (see also FIG. 4). The user identification code 400 and the password code 405 are used to ensure that the user of the client module 210 is authorized to access, retrieve and update data in the server module 205 (see also FIG. 2). Hence, the user identification code 400 and the password code 405 verify the identity of the user of the client module 210. The user identification code 400 and the password code 405 are transmitted via the network 215 from the record system 265 of the client module 210 to the DBS database 235 of the server module 205. The DBS database 235 verifies the accuracy of the user identification code 400 and the password code 405 (step 305).

After the user identification code 400 and the password code 405 are verified, a server work file is retrieved from the DBS database 235 and is downloaded, e.g., transmitted using FTP, from the server work module 225 to the client work module 260 according to a route ID (step 310). The server work file contains a number of records, which contain information relating to a particular event, person, place, procedure or thing. Each server work file includes a route ID, which identifies the client module 210 that is to receive the server work file. In one embodiment, the server work file might contain the records that need to be updated with new information. Each record might include an update flag, which is set when that particular record needs to be updated with hew information. The client work module 260 receives the server work file, makes a copy of the server work file, and saves the copy as a client work file. At step 315, the client work module 260 contacts the server work module 225 to verify that the server work file retrieved from the DBS database 235 has been correctly downloaded from the server module 205 to the client module 210. For example, the client work module 260 might compare the server work file located in the server work module 225 with the client work file. After the server work file has been correctly downloaded, the client work file is opened by the user of the client module 210 or is automatically opened by the record system 265. The user or the record system 265 edits or updates the records of the client work file. In one embodiment, the user or the record system 265 creates or opens an import file, inputs updated records information into the import file, and saves the import file to the client work file (step 320).

At step 325, the client work file is uploaded, e.g., transmitted using FTP, from the client work module 260 to the server work module 225. The server work module 225 checks the format of the client work file and determines whether the format of the client work file is the same or similar as the format of the server work file (step 330). If the client work file has the same or similar format, the server update module 230 generates an update file using the client work file (step 335). The update file includes the information in the client work file and any additional information pertaining to the updated records information.

The server update module 230 distributes, e.g., sends or transmits, or uploads the update file to one or more of databases 235, 240 and 245 (step 340). Therefore, the server work file is automatically batch updated according to the update file. In one embodiment, the server update module 230 distributes the update file to the DBS database 235, the R/6 database 240, and the SAC database 245.

At step 345, the record system 265 performs a security check on the DBS database 235 and the DAE table module 250 to ensure that the data can distribute to SAC table from DBS database.

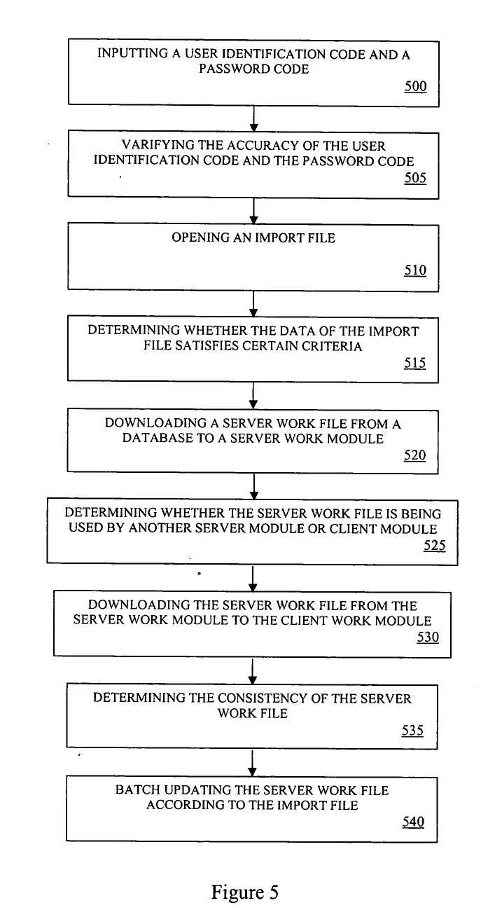

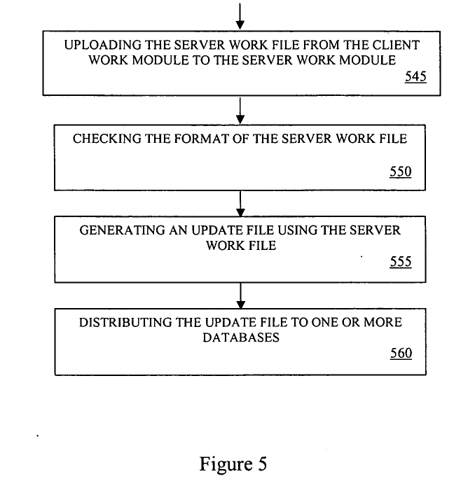

FIG. 5 is a simplified flow chart illustrating a method for batch updating records in the Poseidon system of FIG. 2. At step 500, a user of the client module 210 inputs the user identification code 400 and the password code 405 into the login graphical user interface 410 (see also FIG. 4). The user identification code 400 and the password code 405 are transmitted via the network 215 from the B/R batch update system 265 of the client module 210 to the DBS database 235 of the server module 205. The DBS database 235 verifies the accuracy of the user identification code 400 and the password code 405 (step 505).

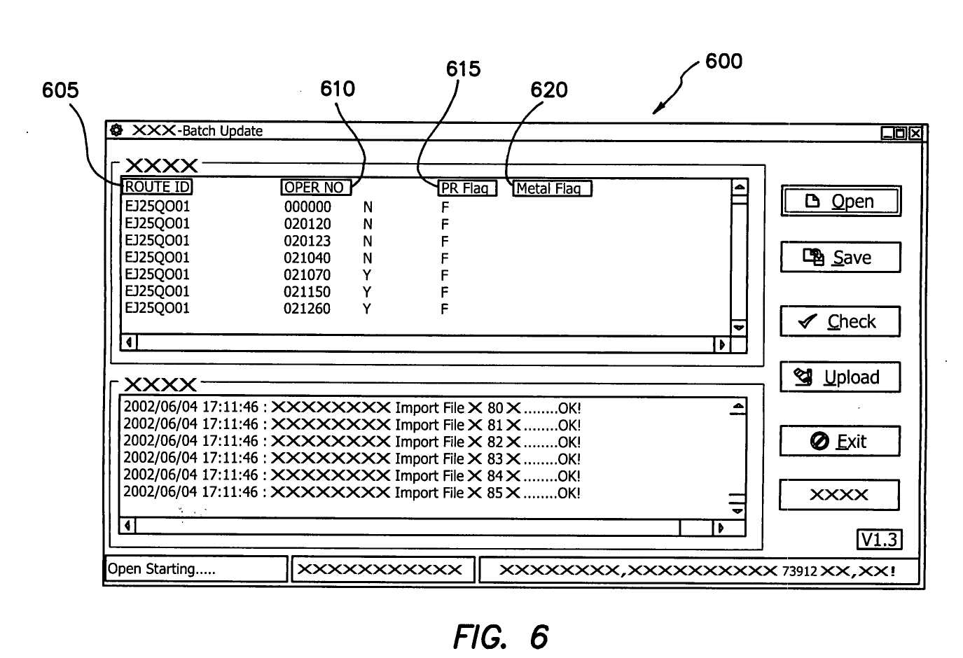

After the user identification code 400 and the password code 405 have been verified, the user of the client 255 can select an open import file icon on the graphical user interface. Once selected, the client 255 sends a command to the B/R batch update system 265 to create or open an import file (step 510). In one embodiment, the B/R batch update system 265 is coupled to an import file module (not shown), which creates or opens the import file. The B/R batch update system 265 has a monitor (not shown) that allows the user to view the opened import file and a keyboard and mouse (not shown) that allows the user to delete, edit and update fields of the opened import file. FIG. 6 is a batch update graphical user interface 600 in accordance with an embodiment of the present invention. The user thereafter saves the import file.

At step 515, the B/R batch update system 265 or the user determines whether the data, e.g., record entries, of the import file satisfies certain criteria. In one embodiment, the criteria include verifying a route ID 605, an operator number 610, a PR Flag 615 (a flag name relating to the prevention of contamination of FAB equipment), and a Metal Flag 620 (another flag name relating to the prevention of contamination of FAB equipment). For example, the B/R batch update system 265 or the user might verify that (1) the entries of the import file contain a single route ID 605, (2) each operator number 610 has less than seven characters, (3) the PR Flag 615 contains an indicator, for example, either a “y” character or a “n” character, and (4) the Metal flag 620 contains an indicator, for example, a character selected from the following items: F, SC, M1, M2, TI, C0, C1, C2, C3, B, wherein each item is a metal attribute flag name. The route ID 605 identifies which client module 210 is to receive the server work file, the operator number 610 is indicative of which operator number in that route ID need to prevent what kind of contamination, the PR Flag 615 is indicative to prevent what kind of contamination of PR, and the Metal Flag 620 is indicative to prevent what kind of contamination of METAL.

If the data of the import file does not satisfy the criteria, another import file is opened. If the data of the import file satisfies the criteria, a server work file is retrieved from the DBS database 235 and is downloaded, e.g., transmitted using FTP, to the server work module 225 according to the route ID 605 (step 520). The server work file contains a number of records, which contain information relating to a particular event, person, place, procedure or thing.

The server work module 225 determines whether the server work file is being used by another server module 205 or client module 210 (step 525). If the server work file is not being used, the server work file is downloaded from the server work module 225 to the client work module 260 according to the route ID 605 (step 530). The client work module 260 determines the consistency of the server work file (step 535). In determining the consistency, route ID information is first obtained from the user's import file, and then it is determined whether this import file operator number has any duplicate situation. If the import file context was correct, then it is determined to download work file from what is referred to as a F2 DB Server. After the server work file has been correctly downloaded, the server work file is automatically batch updated according to the import file (step 540). The server work file is automatically batch updated by the user's import file context that includes the information of route ID, operator number, PR Flag, and Metal Flag. All of this information is updated to the work file. The updated work file is sent to the server, and this updating information is distributed to the R/6 database and the SAC database.

At step 545, the server work file is uploaded, e.g., transmitted using FTP, from the client work module 260 to the server work module 225. The server work module 225 checks the format of the server work file to ensure that the format of the server work file is compatible with the format of the DBS database 235 (step 550). In checking the format, the server can implement a program to check the work file context each record using one or more predefined logic check rules. If the server work file has the correct format, the server update module 230 generates an update file using the import file, the server work file, and any additional information pertaining to the updated records information (step 555).

The server update module 230 distributes, e.g., sends or transmits, or uploads the update file to one or more of databases 235, 240 and 245 (step 560). Hence, the server work file is automatically batch updated according to the update file. In one embodiment, the server update module 230 distributes the update file to the DBS database 235, the R/6 database 240, and the SAC database 245.

The above-described embodiments have been provided by way of example, and the present invention is not limited to these examples. Multiple variations and modification to the disclosed embodiments will occur, to the extent not mutually exclusive, to those skilled in the art upon consideration of the foregoing description. Such variations and modifications, however, fall well within the scope of the present invention as set forth in the following claims.

What is claimed is:

1. A method for batch updating records in a Poseidon system that includes a server module, a database, and a client module, the method comprising the steps of:
downloading a server work file having a plurality of records from the server module to the client module;
verifying the accuracy of the server work file;
updating the plurality of records of the server work file;
uploading the server work file from the client module to the server module;
verifying the format of the server work file; and
sending the server work file to the database.

2. The method of claim 1, further comprising the step of receiving a user identification code and a password code at the server module.

3. The method of claim 2, further comprising the step of verifying the user identification code and the password code.

4. The method of claim 1, wherein the step of verifying the accuracy of the server work file includes the step of contacting the server module to verify that the server work file has been correctly transmitted to the client module.

5. The method of claim 1, further comprising the step of copying the server work file to a client work file.

6. The method of claim 1, wherein the step of updating the plurality of records of the server work file includes performing the updates by a record system.

7. The method of claim 1, wherein the step of updating the plurality of records of the server work file includes performing the updates by a user of the client module.

8. The method of claim 1, further comprising the step of creating an import file using the server work file.

9. The method of claim 1, further comprising the step of generating an update file using the server work file.

10. The method of claim 9, further comprising the step of transmitting the update file to the database.

11. The method of claim 1, wherein the database includes a plurality of databases.

12. The method of claim 11, wherein the plurality of databases include a DBS database, a R6 database, and a SAC database.

13. A method for batch updating records in a computer system that includes a server module, a database coupled to the server module, and a client module coupled to the server module, the method comprising the steps of:
receiving a user identification code and a password code at the server module for verifying the identity of a user of the client module;
opening an import file at the client module;
inputting updated records information into the import file;
downloading a server work file from the server module to the client module;
saving the import file to the server work file; and
uploading the server work file from the client module to the server module.

14. The method of claim 13, further comprising the step of inputting the user identification code and the password code at the client module.

15. The method of claim 13, further comprising the step of verifying the user identification code and the password code.

16. The method of claim 13, further comprising the step of verifying the format of the server work file at the server module.

17. The method of claim 13, further comprising the step of sending the server work file to the database.

18. The method of claim 13, further comprising the step of generating an update file using the server work file.

19. The method of claim 18, further comprising the step of distributing the update file to the database.

20. The method of claim 13, further comprising the step of performing a security check on the database.

21. A method for batch updating records in a computer system that includes a server module, a database coupled to the server module, and a client module coupled to the server module, the method comprising the steps of:
receiving a user identification code and a password code at the server module for verifying the identity of a user of the client module;
opening an import file at the client module;
determining whether the information of the import file satisfies certain criteria;
downloading a server work file from the server module to the client module;
updating the server work file using the import file; and
uploading the server work file from the client module to the server module.

22. The method of claim 21, further comprising the step of inputting the user identification code and the password code at the client module.

23. The method of claim 21, further comprising the step of verifying the user identification code and the password code.

24. The method of claim 21, further comprising the step of verifying the format of the server work file at the server module.

25. The method of claim 21, wherein the information of the import file includes a route ID, an operator number, a PR flag variable, and a Metal flag variable.

26. The method of claim 25, wherein the criteria are satisfied when the entries of the import file contain a single route ID, each operator number has less than seven characters, the PR flag variable contains an indicator, and the Metal flag variable contains an indicator.

27. The method of claim 21, further comprising the step of updating the information of the import file.

28. The method of claim 21, further comprising the step of downloading the server work file from the database to the server module.

29. The method of claim 21, further comprising the step of determining whether the server work file is in use.

30. The method of claim 21, further comprising the step of determining the consistency of the server work file.

31. The method of claim 21, further comprising the step of updating the information of the import file.

32. The method of claim 21, further comprising the step of verifying the format of the server work file at the server module.

33. The method of claim 21, further comprising the step of generating an update file using the server work file.

34. The method of claim 33, further comprising the step of distributing the update file to the database.

35. The method of claim 21, further comprising the step of performing a security check on the database.
